(19) United States
(12) Patent Application Publication
(10) Pub. No.: US 2006/0044822 A1
(43) Pub. Date: Mar. 2, 2006

(54) Electrical tree structure

(76) Inventor: Yoshiyuki Katsumata, Aichi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 11/204,356

(22) Filed: Aug. 16, 2005

(30) Foreign Application Priority Data
Aug. 19, 2004 (JP) 2004-239476

(51) Int. Cl. F21S 4/00

(52) U.S. Cl. 362/564

(57) ABSTRACT

There is provided an electrical tree structure which always keeps spectator's interest, presents a magnificent light show when illuminated, has a specially designed appearance, and creates a pleasing atmosphere regardless of whether it is illuminated or not.

In an electrical tree structure 10 which imitates a tree shape, comprising a single trunk member 11; one or plural middle branch members 12 connected to the trunk member; a plurality of twig members 13 connected to the respective middle branch members, the twig member 13 is comprised of a small branch main portion 14; and an electrical branch portion 60 comprised of a plurality of electrical members each comprised of a plurality of electrical pieces each holding a light-emitting diode at the center of a holding member made of transparent resin.

### BACKGROUND OF THE INVENTION

1. Field of the Invention

The present invention relates to an electrical tree structure and, particularly, to an electrical tree structure in which the top branches of the tree structure are illuminated by light-emitting diodes.

2. Description of the Prior Art

Light-emitting diodes with various colors can be obtained at low cost and, accordingly, the light-emitting diodes are used for various lighting equipment or illumination. For example, an electronically controlled firework assembly which simulates a firework that is shot up into the sky and exploded with a flash, using light-emitting diode is disclosed (see Japanese Unexamined Patent Publication (Kokai) No. 2004-82454).

In Kokai No. 2004-82454, the electronically controlled firework assembly is provided with a spherical supporting body provided on a shaft, and with supporting rods each having, on its front end, a flashing body, and radially extending from the spherical supporting body. The shaft, the spherical supporting body, the supporting rods and flashing body are provided with light-emitting diodes, to simulate, together with sound, the artistic flash of a firework shot up into the sky.

The above assembly simulates a firework shot up into the sky using light and sound. However, after repeating the presentation of the simulated firework several times, spectator's interest is gradually decreased. Additionally, such an electronically controlled firework assembly is not attractive when not illuminated in the daytime. Therefore, it can be hardly said that this assembly create a pleasing atmosphere regardless of whether it is illuminated or not.

### SUMMARY OF THE INVENTION

In view of the above problem, the present invention provides an electrical tree structure which always keeps spectator's interest, presents a magnificent light show when illuminated, has a specially designed appearance, and creates a pleasing atmosphere regardless of whether it is illuminated or not.

Namely, the invention according to claim 1 provides an electrical tree structure which imitates a tree shape, comprising a single trunk member; one or plural middle branch members connected to the trunk member; and a plurality of twig members connected to the respective middle branch members, wherein the twig member is comprised of a small branch main portion; and an electrical branch portion comprised of a plurality of electrical members each comprised of a plurality of electrical pieces each holding a light-emitting diode at the center of a holding member made of transparent resin.

The invention according to claim 2 provides an electrical tree structure according to claim 1, wherein the holding member made of transparent resin is shaped like a flower or leaf.

The invention according to claim 3 provides an electrical tree structure according to claim 1 or 2, wherein the light-emitting diode is coated with a film.

The invention according to claim 4 provides an electrical tree structure according to any one of claims 1 to 3, wherein a protective cover is wound around at least one of the trunk member, the middle branch member and the small branch main portion.

According to an electrical tree structure described in claim 1, there is provided an electrical tree structure which imitates a tree shape, comprising a single trunk member; one or plural middle branch members connected to the trunk member; and a plurality of twig members connected to the respective middle branch members, wherein the twig member is comprised of a small branch main portion; and an electrical branch portion comprised of a plurality of electrical members each comprised of a plurality of electrical pieces each holding a light-emitting diode at the center of a holding member made of transparent resin. Therefore, the electrical tree structure has an appearance imitating a tree, and creates a pleasing atmosphere in the installation location. Further, although the amount of light emitted from each light-emitting diode is small, a magnificent light show can be presented because a number of light-emitting diodes are provided.

According to an electrical tree structure described in claim 2, in the structure described in claim 1, the holding member made of transparent resin is shaped like a flower or leaf. Therefore, as the resemblance between the electrical tree structure and an actual tree is improved regardless of whether it is illuminated or not, the electrical tree structure can always keep spectator's interest.

According to an electrical tree structure described in claim 3, in the structure described in claim 1 or 2, the light-emitting diode is coated with a film. Therefore, a delicate adjustment of color tone can be carried out by a combination of the color of light emitted from the light-emitting diode and the color of the film.

According to an electrical tree structure described in claim 4, in the structure described in any one of claims 1 to 3, a protective cover is wound around at least one of the trunk member, the middle branch member and the small branch main portion. Therefore, the electric wires or the like can be prevented from being damaged due to rain water, dust, etc. Further, the electric wire or the like is covered by the protective cover, to prevent the appearance of the tree (i.e., the appearance of the electrical tree structure) from being damaged.

### DESCRIPTION OF THE PREFERRED EMBODIMENTS

The present invention will be described below with reference to the accompanying drawings.

FIG. 1 shows a side view of the entirety of an electrical tree structure according to the present invention.

FIG. 2 shows a schematic view of connection among a trunk member, a middle branch member and a twig member.

FIG. 3 shows a side view of the entirety of a twig member.

FIG. 4 shows a top view and a side view of a holding member.

FIG. 5 shows a schematic sectional view of an electrical piece.

FIG. 6 shows a schematic sectional view of an electrical piece according to a second embodiment.

FIG. 7 shows a top view of an electrical piece according to third and fourth embodiments.

FIG. 8 shows a schematic view showing a coating process of a film.

FIG. 9 shows a schematic side view of an electrical member.

FIG. 10 shows a schematic side view of an electrical branch portion.

FIG. 11 shows a schematic perspective view of a protective cover.

The appearance of an electrical tree structure 10 and connection among respective members thereof will be described below with reference to FIGS. 1 and 2. As defined in the invention according to claim 1, the electrical tree structure 10 is in imitation of a tree, and is comprised of a single trunk member 11; a plurality of middle branch members 12 connected to the trunk member; and a plurality of twig members 13 connected to the respective middle branch members 12. In the drawings, numeral 60 designates an electrical branch portion that will be described later, and “Gr” designates the ground on which the electrical tree structure is placed. The size of the electrical tree structure 10 varies depending on the kind of a tree. However, the height of the electrical tree structure 10 in the embodiment is 6 m at the maximum, and the height from the ground to the twig members 13 is about 3 m.

The connection among the trunk member 11, the middle branch members 12 and the twig members 13 will be described below. As shown in the illustrated embodiment, the trunk member 11 is comprised of two members, i.e., a trunk base member 11a and a trunk branched member 11b. The plural middle branch members 12 are connected to the trunk member 11 (trunk branched member 11b), and the plural twig members are connected to the middle branch members 12. In FIG. 2, only one middle branch member 12 and only one twig member 13 are shown for convenience of illustration.

Especially, the electrical tree structure 10 in the embodiment is in imitation of a cherry tree and, accordingly, it is required that the tree crown portion thereof spreads out. Thus, the plural middle branch members 12 (three members in the embodiment) can be connected to the trunk member via the trunk branched member 11b, and a plurality of twig members 13 can be connected to each middle branch member 12. This causes the electrical tree structure to resemble an actual cherry tree more faithfully. If an electrical tree structure is in imitation of trees other than a cherry tree, a trunk member, a middle branch member and a twig member of the electrical tree structure can be shaped into desired shapes in view of the shapes of a trunk, branches, etc., of a to-be-imitated tree. Also, the number (one or plural) of the middle branch members can be changed.

As a number of twig members 13 are provided (see FIG. 1), the respective members are connected by an appropriate method such as screw-engagement, welding or fitting in view of the holding strength. For example, the trunk base member 11a is secured to the trunk branched member 11b by bolts via a flange, but the illustration thereof is omitted.

The structure of the twig member 13 will now be described with reference to FIG. 3. As can be seen from the drawing, in the twig member 13, a plurality of electrical branch portions 60 are connected to a small branch main portion 14. According to the embodiment, nine electrical branch portions 60 are connected. However, the number of electrical branch portions 60 is not limited, and varies depending on the appearance of the tree.

Members constituting the electrical branch portion 60 will be described below in detail. As shown in FIG. 4 and defined in the invention according to claim 2, a holding member 20 made of transparent resin in the embodiment is shaped like a flower. As shown in FIG. 4(a), i.e., a top view of the holding member 20, the holding member 20 has five petals 21 and is in imitation of a cherry blossom. As shown in FIG. 4(b), i.e., a side view of the holding member 20, a holding portion 22 for holding a light-emitting diode (LED) is formed on the lower portions of the petals 21. A known resin can be applied to the holding member made of transparent resin if it is transparent and colorless, or transparent with color. For example, polyvinyl chloride resin or the like is used, and the holding member (the petals and the holding portion are integral with each other) is formed by injection-molding or the like.

As shown in FIG. 5, a light-emitting diode 40 is held at a center 23 of the holding member 20 shaped like a flower (especially, the holding portion 22). The holding member and the light-emitting diode constitute an electrical piece 30. A holding hole 24 into which the light-emitting diode can be detachably inserted is formed inside the holding portion 22. This detachability causes the holding member deteriorated by damages to be easily replaced. The light-emitting diode shown by way of example is shaped like a bombshell and, accordingly, the holding hole 24 is shaped into a cylinder in accordance with the shape of the light-emitting diode. The light-emitting diode can be shaped into a shape other than the bombshell and, accordingly, the shape of the holding hole varies depending on the shape of the light-emitting diode. Here, White Lamp/4Ø made by Toyoda Gosei Co., Ltd., NEPW500 made by Nichia Corporation or the like is used as the light-emitting diode. In the drawing, numeral 41 designates electrodes of the light-emitting diode.

Incidentally, the relationship between the color of resin of which the holding member is made and the color of light emitted from the light-emitting diode is as follow. The electrical tree structure in the embodiment is in imitation of a cherry tree. Accordingly, in the flower-shaped portion that emits light, the color of light is white, pink, red, etc., if the holding member 20 is made of a transparent and colorless resin, and the color of light is white if the holding member 20 is made of a transparent resin with pink color.

FIG. 6 shows an electrical piece 30A according to a second embodiment. In the electrical piece 30A shown in the drawing, a plurality of fibrous transparent bodies 26 made of a plastic fiber or a glass fiber are provided on a base portion 27 of the petal 21 of the holding member 20A. The fibrous transparent bodies 26 are in imitation of stamens of a flower. This causes the electrical piece (holding member) to resemble an actual cherry blossom more faithfully. In the drawing, as portions identical to those of the electrical piece 30 in FIG. 5 are designated by the same numerals, the explanation therefore is omitted. The aesthetics of the electrical piece shaped like a cherry blossom is improved by coloring the fibrous transparent bodies 26 with yellow.

FIG. 7 shows an embodiment of a leaf-shaped holding member made of transparent resin. In an electrical piece 30B, according to a third embodiment, shown in FIG. 7(a), a holding member 20B is shaped like a maple leaf. The light-emitting diode 40 is held by a holding portion 22B shown in the drawing. In an electrical piece 30C, according to a fourth embodiment, shown in FIG. 7(b), a holding member 20C is shaped like a holly leaf. The light-emitting diode 40 is held by a holding portion 22C shown in the drawing.

According to the electrical piece 30B, to present the feeling of spring and summer using light emission, not only a green light-emitting diode can be used if the holding member 20B is made of a transparent and colorless resin, but also a white light-emitting diode can be used if the holding member 20B is made of a transparent and green resin. Further, to present the feeling of autumn using light emission, as a maple tree is a deciduous tree, not only a yellow or red light-emitting diode can be used if the holding member 20B is made of a transparent and colorless resin, but also a white light-emitting diode can be used if the holding member 20B is made of a transparent and yellow or red resin.

Additionally, the electrical piece 30C can create a festive mood in Christmas season because it is in imitation of a holly leaf. In this case, in a manner similar to the holding member 20B, not only a green light-emitting diode can be used if the holding member 20B is made of a transparent and colorless resin, but also a white light-emitting diode can be used if the holding member 20B is made of a transparent and green resin. The shapes of a trunk member, middle branch member, twig member, etc. vary depending on the appearance of a tree, i.e., a maple tree or a holly tree, so that the electrical tree structure resembles the actual shape of the tree more faithfully. The shape of the electrical piece is not limited to the shape of a cherry blossom, a maple leaf or a holly leaf.

As described above, the color of light emitted from the electrical piece is constituted by a combination of various colors of light emitted from the light-emitting diode and the holding member. However, the color may be limited depending on the combination.

In order to diversify the color of light emitted from the electrical piece, as defined in the invention according to claim 3, a surface 42 of the light-emitting diode can be coated with a resin film. As shown in FIG. 8(a), the light-emitting diode 40 is covered by a cylindrical resin film 43 whose inner diameter is larger than the diameter of the light-emitting diode. Then, the film 43 is heated to shrink and coat the surface of the light-emitting diode 40, as shown in FIG. 8(b). The shape of the resin film is not limited to a cylindrical shape. A planar film may be adhered to a surface of the light-emitting diode by an appropriate adhesive after being wound therearound. The film is made of resin such as polypropylene or polyvinyl chloride.

For example, the color of the light-emitting diode can be changed into a light red or a pink by coating a white light-emitting diode with a transparent and red film. Therefore, a delicate adjustment of color tone can be carried out by a combination of the holding member made of a transparent and colorless resin and the light-emitting diode coated with a film.

As shown in FIG. 9, the plural electrical pieces described above and shown in the drawings, are bundled to constitute an electrical member 50. According to the embodiment, the electrical piece 30 is connected to a supporting shaft 51 in which electrodes of the light-emitting diode are protected and stored. Wires for supplying electrical power to the light-emitting diode are stored in the supporting shaft 51. The supporting shafts are tied at a shaft base 52. In the embodiment, the electrical piece is in imitation of a cherry blossom and, accordingly, the electrical member is comprised of three electrical pieces which are bundled. Therefore, the number of electrical pieces which are bundled varies depending on the kind of a tree (flower or leaf).

As shown in FIG. 10, a plurality of electrical members 50 are gathered and connected to a supporting branch 61, to constitute the electrical branch portion 60. In the electrical branch portion 60 according to the embodiment, the supporting branch 61 had four connection points 62, and three electrical members 50 (three shaft bases 52) are connected to the respective connection points 62. The wires for supplying electrical power to the electrical member (light-emitting diode) are also stored in the supporting branch 61. In the electrical branch portion, some of supporting branches has only two connection points, but the illustration thereof is omitted.

Thus, as shown in FIG. 3, a plurality of electrical branch portions 60 are connected to the small branch main portion 14, to constitute one twig member 13. Incidentally, in the electrical tree structure according to the embodiment, when a rearrangement operation, a maintenance operation, etc. are carried out, the holding member, the electrical member, the electrical branch portion and the twig member can be selectively replaced in accordance with the amount or degree of the operation. Therefore, not only the operating efficiency can be improved but also the presentation can be easily changed in accordance with the season (for example, the cherry blossom is changed to the cherry leaf).

In the connection among the electrical piece 30 (30A, 30B, 30C), the supporting shaft 51 and the supporting branch 61, the insulation and coating of the members and connected portions are appropriately carried out to prevent inside wires from being damaged due to rain water, dust, etc. entering through the connected portions.

In the electrical tree structure according to the embodiment, an electric wire (various types of harnesses) 150 for supplying electric power to the electrical branch portion is disposed on outer surfaces of the trunk member 11, the middle branch member 12 and the twig member 13, and there is provided a control box (not shown) in which a circuit board to control the turn-on/off of the light-emitting diode is stored. Accordingly, as defined in the invention according to claim 4, a protective cover 100 is wound around at least one of the trunk member 11, the middle branch member 12 and the twig member 13. In the embodiment, as shown in FIG. 11, the protective cover 100 that is shaped like “C” in section, and has a rift 102 is wound around the outer surface of the trunk member 11.

As described above, the protective cover 100 is wound around the trunk member 11 and, then, the rift 102 is closed, so that the electric wire (various types of harnesses) 150 and the control box provided in each electrical branch portion 60 is protected from rain water, dust and the like. The protective cover 100 is made of a durable material such as polyurethane resin or vinyl chloride resin, and a surface pattern 101 of the protective cover has a design that imitates an actual tree bark (e.g., cherry tree bark). Therefore, as the electric wire and the control box can be covered by the protective cover, the appearance of the tree (i.e., the appearance of the electrical tree structure) is not damaged.

In particular, the protective cover 100 is provided with the rift 102 in the embodiment and, accordingly, the convenience for attaching/detaching the protective cover to/from the trunk member is improved, and the replacement of protective cover itself, the maintenance of the electric wire, the control box (not shown) and the connected portions of the respective members, can be easily carried out. The protective cover may be shaped into a simple cylindrical shape without a rift. Additionally, stepped portions (not shown) which can be engaged with each other may be provided on a top portion 103 and a bottom portion 104 of the protective cover, respectively, so that the protective covers can be easily connected to each other.

The attaching operation of the protective cover to the middle branch member 12 or the twig member 13 is similar to that for the trunk member 11 and, accordingly, is not described and not shown in the drawings.

As described above and shown in the drawings, according to the electrical tree structure in the embodiment, 8,000 to 12,000 of electrical pieces 30 are connected in total, depending on the size of the electrical tree structure. Alternatively, two of the electrical pieces that constitute the electrical member may be successively turned on (i.e., one of them is successively turned off) so that two-thirds of all electrical pieces in the electrical tree structure can be successively turned on, by forming a preferable power supply circuit. The mode of light emission and illumination can be set without restraint, in accordance with the installation location of the electrical tree structure (e.g., amusement park, children'splay facilities) and requests from customers.

### BRIEF DESCRIPTION OF THE DRAWINGS

FIG. 1 shows a side view of the entirety of an electrical tree structure according to the present invention;

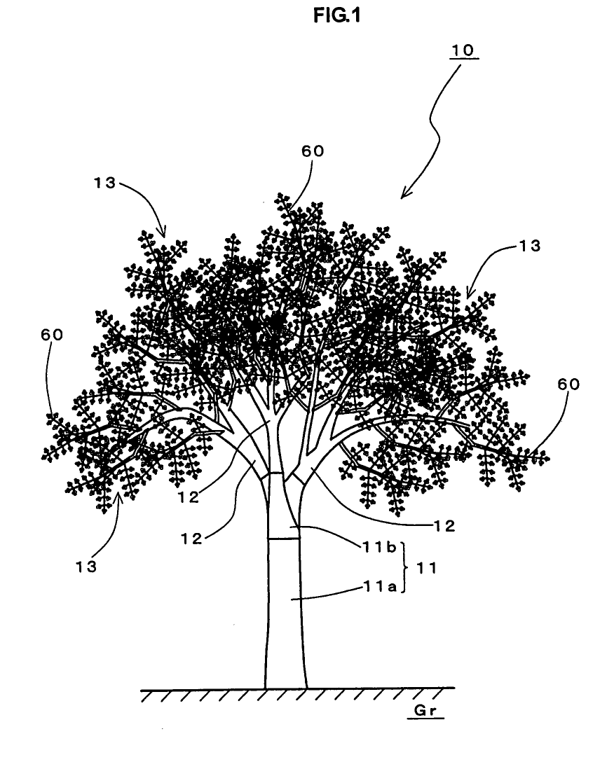

FIG. 2 shows a schematic view of connection among a trunk member, a middle branch member and a twig member;

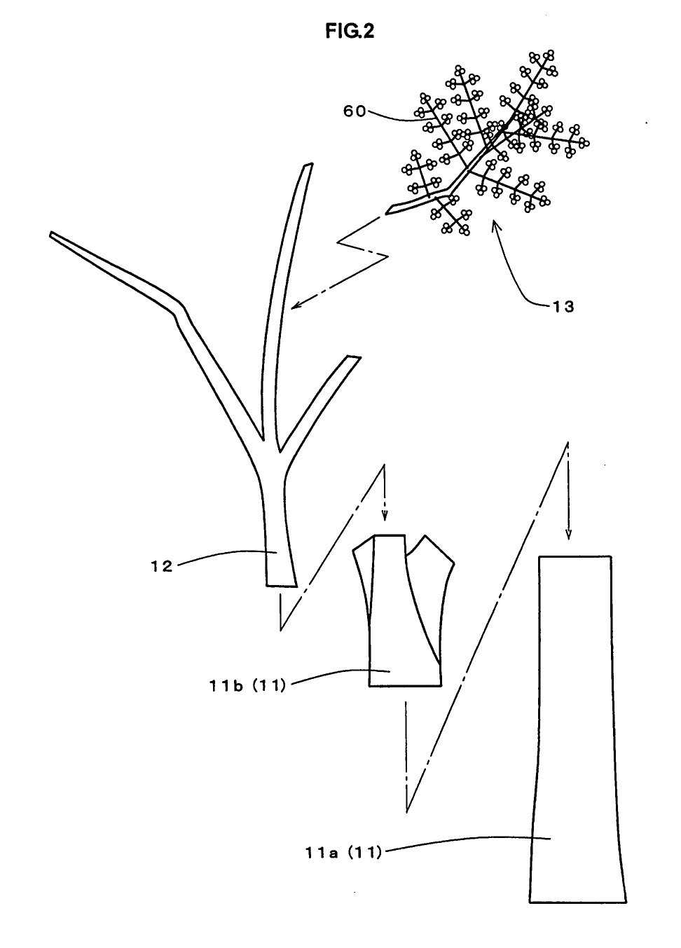

FIG. 3 shows a side view of the entirety of a twig member;

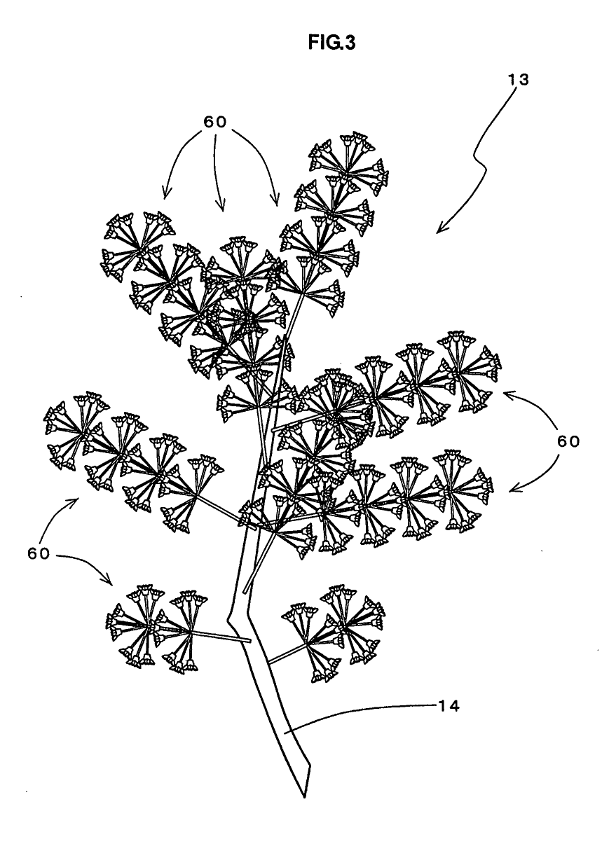

FIG. 4 shows a top view and a side view of a holding member;

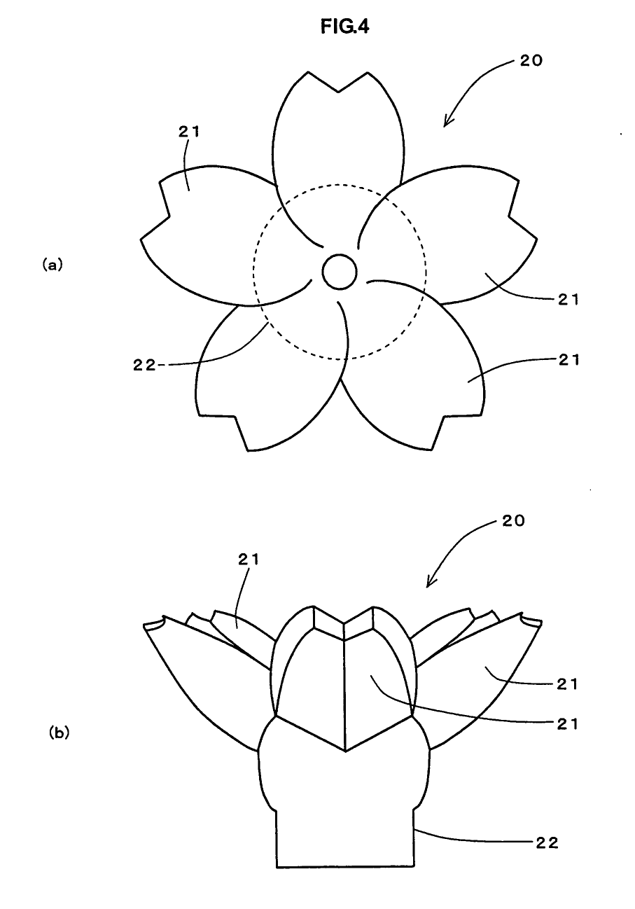

FIG. 5 shows a schematic sectional view of an electrical piece;

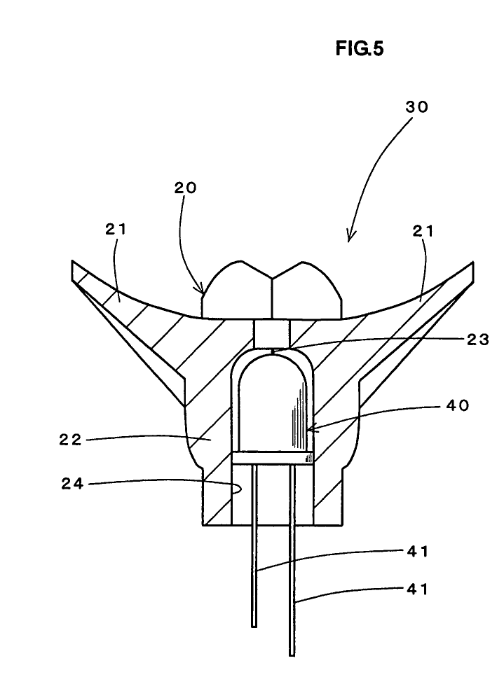

FIG. 6 shows a schematic sectional view of an electrical piece according to a second embodiment;

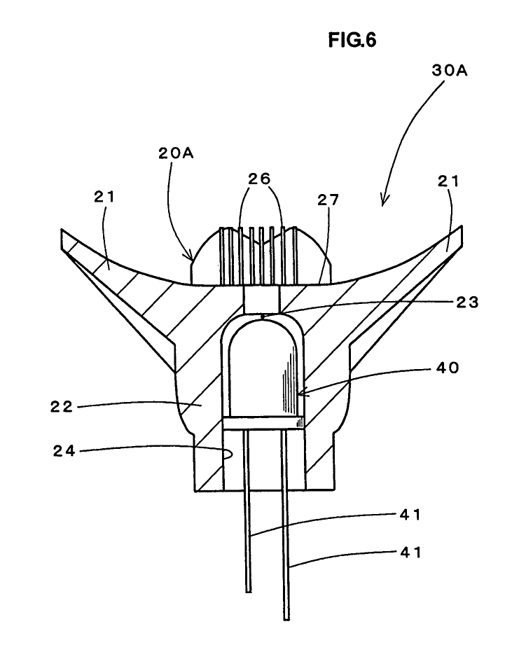

FIG. 7 shows top views of electrical pieces according to a third embodiment and a fourth embodiment;

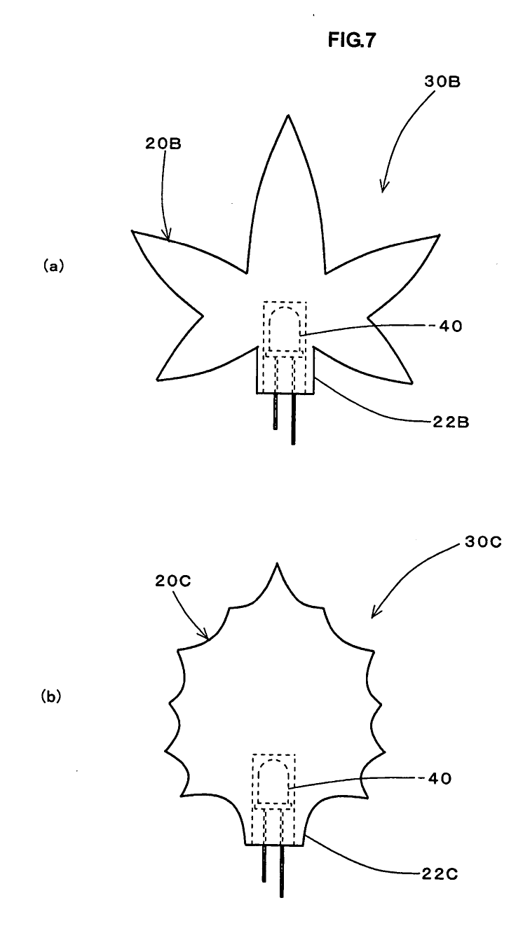

FIG. 8 shows a schematic view of a coating process of a film;

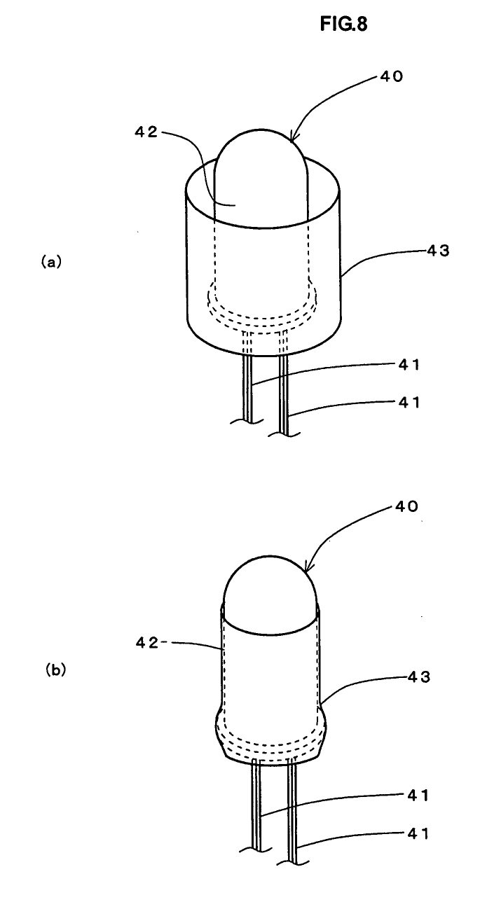

FIG. 9 shows a schematic side view of an electrical member;

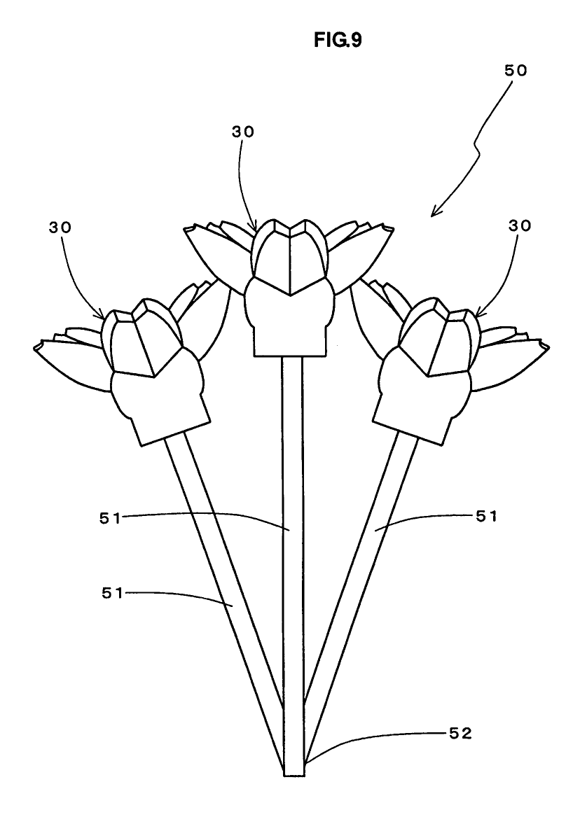

FIG. 10 shows a schematic side view of an electrical branch portion; and

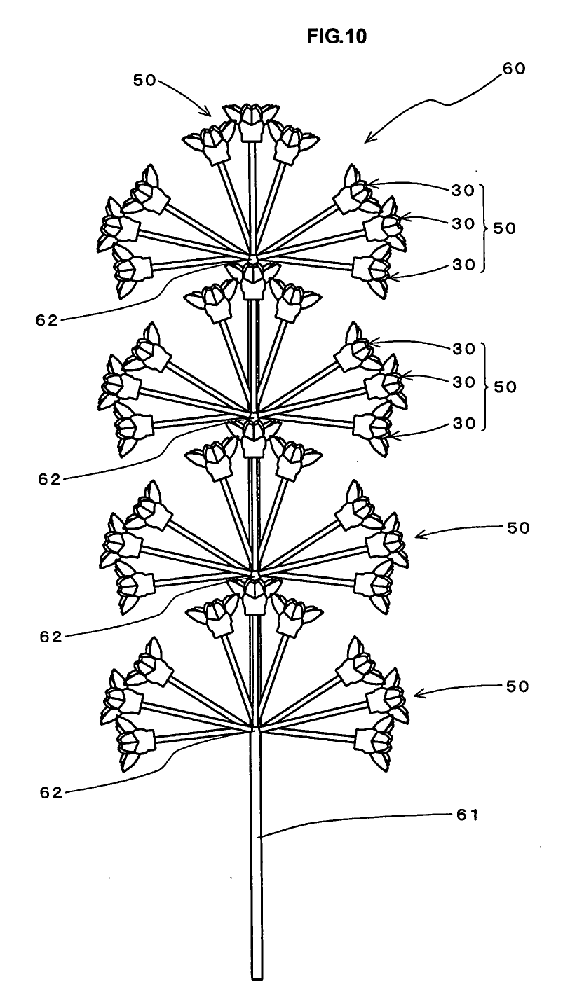

FIG. 11 shows a schematic perspective view of a protective cover.

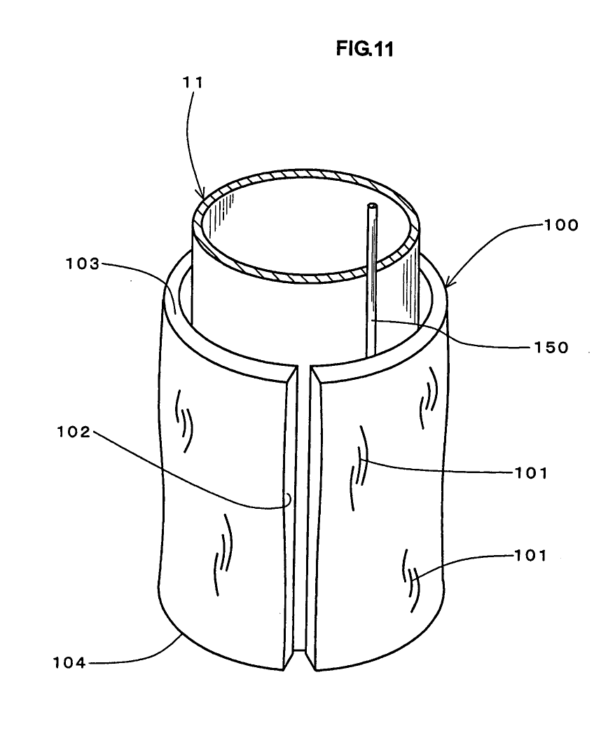

What is claimed is:

1. An electrical tree structure which imitates a tree shape, comprising
a single trunk member;
one or plural middle branch members connected to the trunk member;
a plurality of twig members connected to the respective middle branch members, wherein
the twig member is comprised of a small branch main portion; and an electrical branch portion comprised of a plurality of electrical members each comprised of a plurality of electrical pieces each holding a light-emitting diode at the center of a holding member made of transparent resin.

2. An electrical tree structure according to claim 1, wherein the holding member made of transparent resin is shaped like a flower or leaf.

3. An electrical tree structure according to claim 1 or 2, wherein the light-emitting diode is coated with a film.

4. An electrical tree structure according to any one of claims 1 to 3, wherein a protective cover is wound around at least one of the trunk member, the middle branch member and the small branch main portion.
